(19) United States
(12) Patent Application Publication
(10) Pub. No.: US 2026/0212843 A1
(43) Pub. Date: Jul. 23, 2026

(54) Trombone Fusion Valve Attachment

(71) Applicant: Juan Ramon Rodriguez, Deltona, FL (US)

(72) Inventor: Juan Ramon Rodriguez, Deltona, FL (US)

(21) Appl. No.: 19/345,867

(22) Filed: Sep. 30, 2025

Related U.S. Application Data
(60) Provisional application No. 63/681,041, filed on Sep. 30, 2024.

(51) Int. Cl. G10D 9/04; G10D 7/10

(52) U.S. Cl. CPC G10D 9/04; G10D 7/10

(57) ABSTRACT

This invention relates to brass musical instruments in the key of B flat and C. The Trombone Fusion Valve Attachment device was created to fill the need to fuse two different instruments into a hybrid one, by using the bell section of one and the valve section of the other. It is placed in between the valve section of a B flat compact marching trombone (without the bell) and the Bell section of any C key slide trombone brand (without the slide).

### REFERENCE TO RELATED APPLICATIONS

The present application claims priority under 35 USC 119 to U.S. Provisional Application No. 63/681,041 filed on Sep. 30, 2024. Said Provisional Application No. 63/681,041 is hereby incorporated by reference.

### BACKGROUND OF THE INVENTION

This novel discovery pertains to the field of slide trombones, valve trombones, compact marching trombones and bass trumpets. The sound of the valve trombone and the compact marching trombone is like the sound of a slide trombone, but it is not the same. Some musicians prefer the sound of the slide trombone bell, because it is not coiled, it is more projecting and vibrant.

There is not a device or method to enable the connection between the compact valves section of a compact marching trombone and the bell section of a slide trombone. Another problem is that, if the musician's arm is injured, or if he or she, decides to learn how to use the valves, they were obliged to acquire a valve trombone besides their slide trombone, having no other option because valve trombones cannot use the bell section of a different trombone brand. Therefore, there was the necessity, to give trombone players the ability to use their preferred trombone bell, by acquiring a (bell less) valves section fitted with the Trombone Fusion Valve Attachment device. The Trombone Fusion Valve Attachment solves those problems.

### BRIEF STATEMENT OF THE INVENTION

The fusion of the two instruments sections has the advantage of transforming the resulting instrument into a transposing B flat Instrument. Another advantage is that it allows the trombonist to test the sound of different bell types by using the same valves section attaching different bells brands and then decide which one sound is the best for his project.

Trombone makers will be able to offer the customer, a musical instrument with the bell, the slide and a compact valve section, fitted with the Trombone Fusion Valve Attachment. Another great advantage is that the fusion of these instruments will have a tuning slide in the valves section, and a tuning slide on the bell section. And if made properly, with the help of a slide guide, the bell section can be used as a slide for effects.

### BRIEF DESCRIPTION OF DRAWINGS

FIG. 1 illustrates a partial view of the valves section of a compact marching trombone 14, with the fully assembled trombone fusion valve attachment device, joined to the first valve casing air exit tube 2. There can be seen, the straight outer slide tube 1, the (chrome plated) inside slide tube 5 (see thru), the braces 3, the flange sleeve 11 joined to the outer slide tube 1, the ring joined to the flange 6, the barrel 7 screwed to the ring 6 and a threaded tenon 9 joined to the barrel 7, ready to receive the bell of a slide trombone.

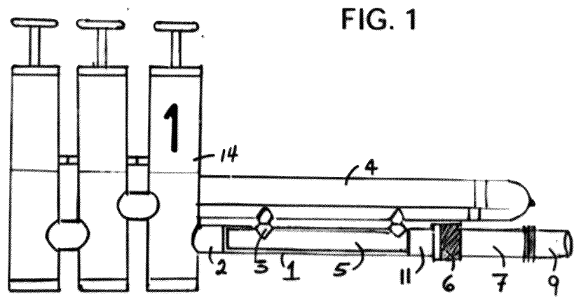

FIG. 2 illustrates a partial view of the valves section of a compact marching trombone, with a partially disassembled trombone fusion valve attachment device. There can be seen, an S shaped outer slide tube 1 joined to the first valve casing air exit tube 2, two braces 3, the fist slide tubes 4 and crook, the (chrome plated) inside slide tube 5, the ring 6, the barrel 7, the bell connecting ring 8, two tenons 9, 12, 13, the Z shaped braces 10 holding the ring 6, and the sleeve flange fitting 11 joined to the ring 6.

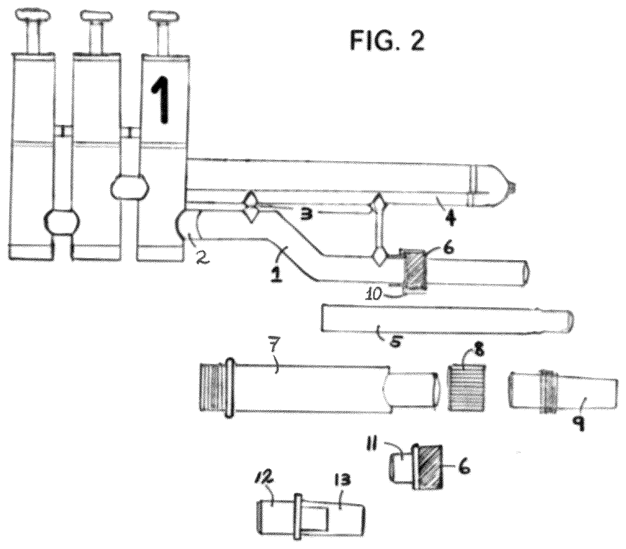

1. A method of making a tubular attachment device for connecting a compact trombone valves section to a bell section of any slide trombone, the method comprising:
a) connecting an outer slide tube to a valve casing air exit tube of the compact trombone replacing the bell;
b) attaching to a tenon an inside slide tube;
c) c) forming a mini slide by attaching the inside slide tube and the tenon to a barrel and inserting into the outer slide tube;
d) attaching the tenon to the bell section;
e) bracing a ring to the outer slide tube and attaching the barrel.

2. The method of claim 1, where the tenon is attached to the outer slide tube replacing the inside slide tube.

3. The method of claim 1, where the tapered tip of a trombone tenon is configured to be removable and insertable to a fitting.
